(19) United States
(12) Patent Application Publication
(10) Pub. No.: US 2009/0217864 A1
(43) Pub. Date: Sep. 3, 2009

(54) Device with visual temperature indicator

(76) Inventors: Ray F. Stewart, Emerald Lake Hills, CA (US); Kathryn Morton, Palo Alto, CA (US)

Correspondence Address: King & Spalding LLP, P.O. Box 889, Belmont, CA, 94002-0889, US

(21) Appl. No.: 11/887,013

(22) PCT Filed: Mar. 22, 2006
(86) PCT No.: PCT/US2006/010615

§ 371 Date: Feb. 2, 2009

Related U.S. Application Data
(60) Provisional application No. 60/664,874, filed on Mar. 23, 2005.

(51) Int. Cl. G01K 1/02; G01K 11/12

(52) U.S. Cl. 116/216; 374/162; 374/E01.002; 374/E11.018

(57) ABSTRACT

A thermally sensitive device having a thermochromic indicating member is described. The device is prepared from a thermally conductive material and has at one end an indicating member that is formed from a thermochromic material.

### TECHNICAL FIELD

The subject matter described herein relates to an apparatus for signaling to a user that an item being heated, such as a food item, has reached a predetermined internal temperature. More specifically, the subject matter relates to a thermally-responsive indicating device capable of providing a visual signal upon attainment of a specified internal temperature of the item being heated.

### BACKGROUND

Thermally responsive indicators are useful in a variety of fields for providing a visual indication of the attainment of a specified temperature. For example, use of thermal indicating devices have been described for use in relief valves (U.S. Pat. No. 5,495,865), in animals for detecting an elevated body temperature (U.S. Pat. No. 4,083,364), in electrical conductors (German Patent No. 3,229,020), and in fire sprinklers (U.S. Pat. Nos. 4,896,728; 4,006,780).

Thermally responsive indicating devices have found particular success in the preparation of food products, particularly meat and fowl. Such devices can be used to indicate the elevated temperature of the interior of the food product, rather than the temperature of the exterior thereof. By indicating the attainment of a specified internal temperature of the food product, the device can signal when the food product has completed cooking. Several such devices for use in cooking food are known and typically are based on the concept of a plunger biased by a spring to be released into an extended position upon attaining a specified temperature (U.S. Pat. Nos. 5,988,102; 5,537,950). A retaining means, which is typically a fusible material, holds the plunger in a retracted position until the fusible material yields, at which time a spring urges the plunger into an extended position. When in the extended position, the plunger provides a visual indication to the user that the food is “done.” To further enhance the visibility of the plunger when it is in the extended position, a cap may be attached to the end thereof.

One disadvantage associated with these so-called “pop-up” timers is that the user has no indication, prior to the plunger being released into its extended position that the device is functioning properly. The user also does not know the time remaining for the cooking process to be completed. Thus, there remains a need for a cooking timer device that signals the user when the food is reaching a state of “partial completion” to signal the use that the product is working and that a certain amount of time, for example 30-45 minutes, remains until the cooking process is finished.

One of the difficulties in designing such a cooking timer is that the temperature of interest is at the center of the food, while for ease of visibility, it is preferable for the indication to be at the surface of the food. Problems with current timer designs are that they are relatively expensive, and/or single temperature indicators, and/or measure the surface temperature, and/or are less accurate indicators of internal food temperature and thus less accurate indicators of cooking time.

The foregoing examples of the related art and limitations related therewith are intended to be illustrative and not exclusive. Other limitations of the related art will become apparent to those of skill in the art upon a reading of the specification and a study of the drawings.

### SUMMARY

In one aspect, a device comprising an elongate member having first and second opposing ends, and disposed on one of the ends, a thermochromic material, wherein the elongate member is adapted for thermal transfer such that the thermochromic material responds to a temperature detected by the opposing end.

In another aspect, a device for detecting the internal temperature of a bulk medium is provided. The device is comprised of an elongate member having a first end and a second opposing end, a thermochromic material disposed on the first end; wherein the second end is adapted for insertion into a bulk medium and the elongate member is adapted for thermal transfer such that the thermochromic material responds to a temperature detected by the second end when inserted into the bulk medium.

In yet another aspect, a device for detecting the internal temperature of a food item is provided. The device is comprised of an elongate member having a first end and a second opposing end, a thermochromic material disposed on the first end; wherein the second end is adapted for insertion into the food item, and wherein the elongate member is adapted for thermal transfer such that the thermochromic material responds to an internal temperature of the food item detected by the second end when inserted into the food item.

In another aspect, a thermal indicator device that responds to temperature within the interior of an item, such as the interior of a food item being heated, for example, in an oven, is provided.

In one embodiment, the thermal indicator device provides a visual indicator that a certain temperature inside the item has been reached, the visual indicator occurring at a predictable temperature.

In another embodiment, the thermal indicator device includes both a visual indicator that signals a user that a certain amount of time remains in the cooking process, and a second visual indicator that signals the user that the cooking process is complete.

The thermal indicator device provides a visual thermal indicator that is relatively insensitive to the temperature exterior to the item being heated and/or to the temperature of the exterior of the item being heated.

The thermal indicator device is suitable for use in various heating environments, including but not limited to conventional kitchen ovens, industrial ovens, convection ovens, and microwave ovens.

In one embodiment, the thermal indicator device lacks a visual indicator that a certain internal temperature has been reached, but comprises an indicator, such as a “pop-up” indicator, where the device or certain components of the device is formed of a thermally conductive material with a conductivity of greater than about 0.5 W/(m·K).

The thermal indicator device in other embodiments can be combined with a second temperature measuring device, particularly a temperature triggered physical device such as a thermo-mechanical (“pop-up”) indicator.

The thermal indicator device, in one embodiment, signals the user prior to the triggering of a physical triggered device such as a “pop up” indicator.

In another embodiment, the thermal indicator device can include two or more visual indicators.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a graph of temperature, in ° C., as a function of the distance from the center of the food item, initially (time zero, diamonds) and after heating for 30, 60, 90, and 120 minutes;

FIG. 2 is an illustration of a simple thermal indictor device; and

FIG. 3 shows illustrations of various devices with differing ratios of stem/ring.

### DETAILED DESCRIPTION

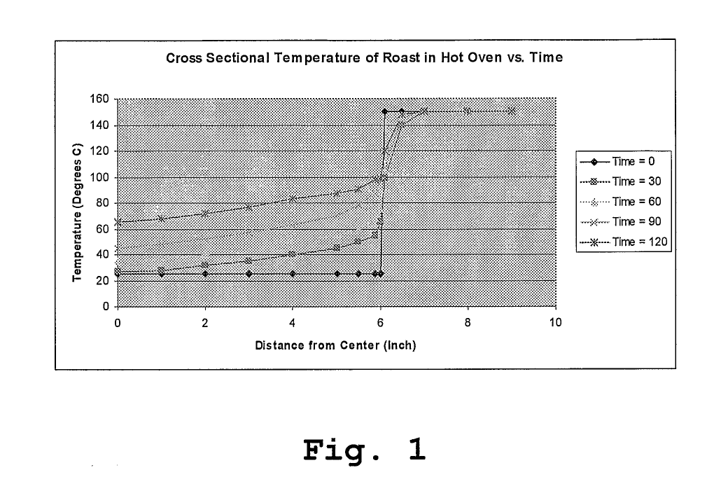

In one aspect, a cost effective and versatile device is provided, the device intended for measuring the internal temperature of a bulk medium or component and signaling to a user that a predetermined internal temperature of the item or component has been achieved. A study was conducted to illustrate the issues involved in design of such a temperature indicator for use, for example, in food preparation. In this study, a roast having a diameter of six inches was obtained. Thermocouples were placed in the roast at various depths: in the center of the roast (zero inches from center), 1 inch from center, 2 inches from center, 3 inches from center, 4 inches from center, 5 inches from center, 5.5 inches from center, 5.8 inches from center and 6 inches from center (external surface). The temperature at each position was measured prior to cooking and at 30 minutes, 60 minutes, 90 minutes and 120 minutes during cooking. The results are shown in FIG. 1.

The initial temperature of the roast was about 20° C., and the temperature increased quickly after placing it in the oven, due to the large temperature gradient between the oven and the food product. Over time, the food item heats by absorption, conductive, and convective heating from the hot air and infrared radiation of the oven. The temperature at external surface of the roast (six inches from center) does not mimic that of the interior because of the large thermal gradient and low thermal conductivity of the meat (approximately 0.5 W/(m·K)). As cooking continued, the temperature through the food item becomes more uniform, but is still subject to large differences. To further complicate the analysis, the exterior temperature of the roast may also be effected by the evaporation of water which will tend to cause the outer surface to initially not exceed 100° C.

The thermal behavior of the item being heated, such as a food item, will be quite sensitive to many factors including the temperature of the oven, the size of the item, the item's geometry, and initial temperature. These factors make it very difficult to accurately predict the amount of time the cooking process will require. In the case where one attempts to estimate the cooking progress by the surface (or near surface) temperature of the item, it will be erratic and subject to wide variations. However, if the internal temperature of the item could be easily monitored, then prediction would be much easier.

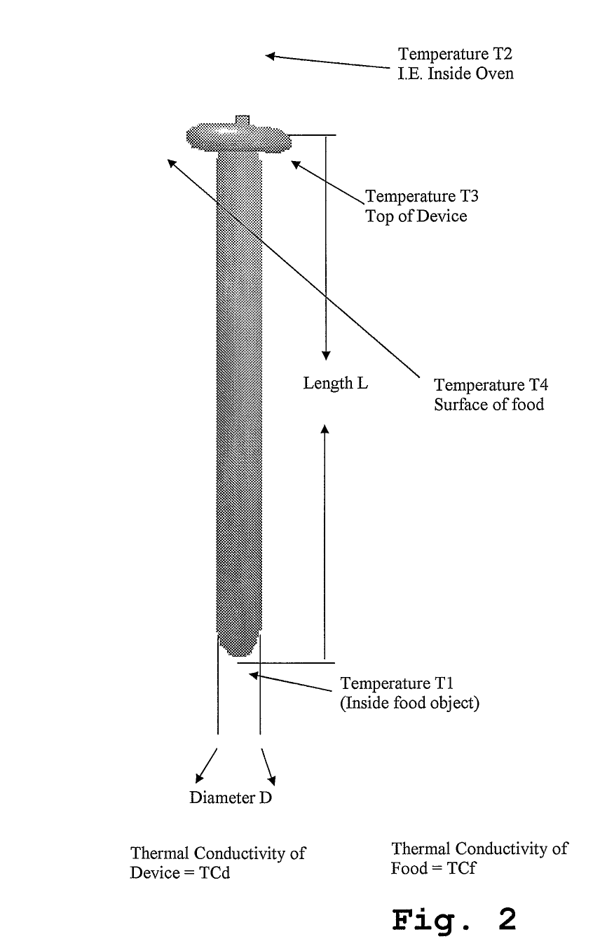

Referring now to FIG. 2, an exemplary, simple thermally responsive device is shown for consideration of the parameters needed for selection of suitable materials and design elements. The device comprises a first elongate element (barrel) having a length L and, preferably formed of a material having a thermal conductivity greater than about 0.5 W/(m·K), more preferably greater than 2 W/(m·K). The thermal conductivity of the material forming the elongate barrel member in theory has no upper desirable limit, but for practical reasons is generally less than 250 to 300 W/(m·K). The elongate member may be solid or hollow or some combination thereof. One end of the elongate member is adapted to be inserted into an item and the other opposing end is adapted to have at least a portion of it's surface be thermochromic. The thermochromic portion may be of any general shape, but circular is generally desirable.

The thermochromic material (or materials or system) is generally designed to change color between a temperature about 40° C. and about 90° C., although for industrial or food safety applications, temperatures greater or lower may be desired, for example to be in the neighborhood of 0° C. to monitor freezing and to be at or above 100° C. to monitor sterilization. The device may optionally comprise an internal mechanism to trigger a mechanical indicator at a pre-determined temperature, for example a temperature-sensitive material and a spring-loaded shaft or other known means, as discussed above.

The device may be essentially cylindrical or in a preferred embodiment may be star shaped in cross section or may have structures to increase surface area, for example fins that serve to increase the thermal conductivity of the device. In one preferred embodiment, the device has relatively more surface area on the portion adapted to be inside the object than the portion of the device on the external surface of the object.

In use, the device is placed into the object to be heated or monitored such that one end is in contact with an interior region of the object, the point of contact with the interior can be anywhere from ¼″ to 2″ or more from the external surface of the object, depending on the application. Notably, the end of the device adapted for insertion into the object generally does not penetrate through the object, but remains in an interior region of the object in order to monitor the internal temperature of the object. The opposing end of the elongate device is proximate to the exterior surface of the object. Disposed on the outer surface of the device, and more specifically, disposed on the opposing end of the device that remains proximate the exterior surface of the object, is an indicating member formed of a thermochromic material and designed to respond to a desired temperature. Optionally the thermochromic indicating member is covered with a layer of thermally insulating (thermal conductivity less than about 2 W/(m·K)) transparent material.

The material of construction and cross sectional area of the device are configured such that the temperature of the opposing end of the device on which the thermochromic member is positioned is controlled largely by the internal temperature of the object. This is achieved, in part, by fabricating the device such that the thermochromic indicating member is thermal communication with the elongate barrel of the device and with the end of the device that is in contact with an interior region of the object, to permit a continuous thermally conductive path from the thermochromic indicating member to the opposing end of the device inserted into the object.

In use, the indicating device is inserted into the object, which is then placed in a heating device, such as a conventional or microwave oven, or in an environment where monitoring of the temperature is desired. If the object is warmed, there will generally be a thermal gradient established such that the outside of the object is warmer than the interior. For example, when the object is placed in a conventional oven, the outer portion of the device will be warmed by hot air (convection and conduction) and optionally by infrared radiation and will become warmer than the interior of the object. Heat will then be conducted away from the hot exterior exposed area of the device (where the thermochromic indicating member is positioned) and into the interior of the object by the thermally conductive material, whereupon the heat will be dissipated. As the interior temperature of the object increases with increased time in the oven, the amount of heat conduction along the device will naturally decrease. At some point, the interior of the object will reach a temperature corresponding to a pre-determined temperature at which the thermochromic indicating member is activated to change color, signaling to a user that the temperature has been achieved.

When heating occurs in a microwave oven the process will be similar or potentially reversed depending on the item, in particular food item, being heated. In a microwave oven most of the energy is absorbed inside the food item, rather than the surface, so that the food item is essentially heated from the inside out. Accordingly, heat from inside the food object may be conducted outward by the device, gradually raising the temperature of the outer portion of the device where the thermochromic indicating member is positioned.

In both a conventional oven and in a microwave oven, the device will closely track the temperature inside the item, allowing a reliable measurement of heating or cooking progress. When the pre-determined temperature is obtained, the visual thermochromic indicator will be activated and signal to the user that the pre-determined temperature has been reached. Optionally, after the visual thermochromic indicator has triggered, the heating will continue to such a point that a second indicator device triggers, the second indicator device being in some embodiments a thermo-mechanical indicator, such as a “pop-up” indicator, or in another embodiment, a second thermochromic indicating member that triggers at a second, pre-determined temperature. It will be appreciated that the order of indicating triggers can be reversed, such that the thermomechanical indicator triggers first and then subsequently the thermochromic indicator is activated.

The thermochromic material from which the thermochromic indicating member is formed may change abruptly or may change gradually depending on the desired effect and materials employed. Also, the indicator may be a discreet shape (for example a ring or dot) or it may be designed as a plurality of elements that change either at the same temperature or different temperatures. The thermochromic material may also be in the form of letters, numbers or symbols, for example printed to read “15 Minutes” etc.

The thermochromic material may be reversible or irreversible and may also simply go from opaque to clear, or from clear to opaque, or other known system.

Thus, in one general embodiment, the device comprises an elongate member that is formed of a thermally conductive material. The elongate member has two ends, a first end suitable for insertion into the item to be heated and a second opposing end thermally coupled to the first end. As used herein, “insertion into” intends that the end is introduced into an item without complete penetration of the item. Adjacent or directly in contact with the second opposing end is disposed an element comprised of a thermochromic material. The thermochromic material may optionally be coated (partially or completely) with a thermally insulting material. The first end of the device inserted into the item to be heated conducts heat from the item to the thermochromic material such that when a desired internal temperature is attained, the thermochromic material undergoes an observable or measurable change.

In another embodiment the barrel of a thermo-mechanical cooking timer is rendered thermally conductive and a thermochromic material is disposed around the rim of the barrel such that the thermochromic material changes color before the thermo-mechanical indicating member is activated. In this manner, the user can be notified some time period before the item is heated to a desired temperature, e.g., before the food is done cooking or before the polymeric mixture reaches a certain temperature.

In another embodiment two or more thermochromic materials may be placed in thermal communication with the interior of the item so that the progress of the heating or cooking may be monitored. In one such case, one end of the elongate member is inserted into the item and the other end is coated with variable thermchromnic material(s) such that a gradual or abrupt color change occurs signaling various stages of heating.

In another embodiment, the stem of a thermo-mechanical “pop up” timer is rendered thermally conductive such that a thermochromic material disposed on it responds to the temperature inside the barrel the timer.

An optional feature suitable for use in any of the above embodiments, there is disposed over the thermochromic material a second material which is transparent. In another optional embodiment, the transparent material has a thermal conductivity lower than the thermally conductive elongate barrel member.

The device is preferably formed of a material with a thermal conductivity of greater than about 0.5 W/(m·K), more preferably greater than about 1 W/(m·K), still more preferably greater than about 1.5 W/(m·K). Thermal conductivity, A, is the quantity of heat transmitted, due to unit temperature gradient, in unit time under steady conditions in a direction normal to a surface of unit area, when the heat transfer is dependent only on the temperature gradient:

thermal conductivity=heat flow rate/(distance×temperature gradient)

In the Si system of units, thermal conductivity is measured in watt/(metre×kelvin), denoted herein as watts per metre-kelvin, W·m⁻¹·K⁻¹ or W/(m·K), where watt is the unit of power, metre is the unit of distance, and Kelvin is the unit of temperature. Thermal conductivity values are also reported in the literature as cal/(m·h·° C.). By multiplying a value in units cal/(m·h·° C.) by 0.001162 (4.184/3600) it is converted to the SI units of W/(m·K), assuming the calories are the small or gram calories, not kilogram or food calories.

The thermal conductivity of various materials is tabulated in many reference sources. Table 1 lists the thermal conductivity of common materials.

TABLE 1
Thermal Conductivity for some common Materials
Thermal Conductivity - k -(W/m · K)

| | Temperature (° C.) | | |
|---|---|---|---|
| Material | 25 | 125 | 225 |
| Aluminum | 250 | 255 | 250 |
| Antimony | 18.5 | | |
| Asphalt | 1.26 | | |
| Brass | 109 | | |
| Brick dense | 1.6 | | |
| Cadmium | 92 | | |
| Carbon | 1.7 | | |
| Copper | 401 | 400 | 398 |
| Carbon Steel | 54 | 51 | 47 |
| Cotton Wool insulation | 0.029 | | |
| Epoxy | 0.35 | | |
| Felt insulation | 0.04 | | |
| Glass | 1.05 | | |
| Ice | 2.18 | | |
| Iron | 80 | 68 | 60 |
| Magnesium | 156 | | |
| Mica | 0.75 | | |
| Nylon 6 | 0.25 | | |
| Polyethylene HD | 0.5 | | |
| Polystyrene expanded | 0.03 | | |
| Steel | 46 | | |
| Stainless Steel | 16 | 17 | 19 |
| Water | 0.58 | | |
| Wood | 0.13 | | |

Commercially available thermally conductive plastics can be prepared by adding thermally conductive fillers, such as alumina boron nitride, calcium carbonate, etc., to standard polymers and have conductivities in the range of 1 to 18.

Existing timers are generally constructed of plastics, for example nylon, polypropylene, polycarbonate and the like for ease of manufacture and low cost. Polymers such as these have inherently low thermal conductivity. Compared to water and simple metals such as aluminum and steel, most polymers have very low thermal conductivities.

Because thermal conductivity is a bulk property, the effective ability of a specific device to conduct heat from one location to another will be defined by it's bulk thermal conductivity in addition to it's specific geometry. The thermal transport properties of objects can be calculated by mathematical analysis and this is a consideration in the design of many common objects, for example computer circuit boards, automobile head lamps, etc. Extensive literature exists on various methods to calculate steady state and transient properties of devices. It is also possible to construct useful computer models, for example finite element models that can predict both the steady state and transient thermal behavior of simple or complex devices. See, for example, TRANSPORT PHENOMENA, by Bird, Stewart, and Lightfoot, for a general disclosure of thermal modeling.

Selection of the thermal conductivity of the material for forming the device and selection of the geometric design of the device permits fabrication of a device that provides a reliable visual indicator of the internal temperature of an item being heated. The device typically has a minimum thermal conductivity in order that the visual indicator responds primarily to the interior temperature of the item to be monitored rather than to the exterior environment.

The material forming the device and the device configuration can vary greatly, depending in part on the specific application. For example, in the case of a cooking indicator for a turkey, in one embodiment, the device is constructed such that the under steady-state conditions the device will have an outer temperature that more closely resembles the temperature inside the turkey than the temperature of the turkey skin or the ambient air inside the oven.

The device may be made from a wide range of material provided they have suitable thermal, mechanical, and toxicology properties. Preferred materials of construction will preferably meet one or more of the following criteria: (i) a thermal conductivity greater than 0.25 W/(m·K), preferably greater than 0.5 W/(m·K), more preferably greater than 2 W/(m·K); (ii) a heat distortion temperature of greater than about 80° C., the heat distortion being measured by a standard ASTM test method; (iii) non toxic to humans; and/or (iv) an extractable content less than 1% when extracted according to a standardized method for determining quantity of extracts.

Without intending the following to be limiting, exemplary materials include metal and polymers. Exemplary metals include aluminum and alloys of aluminum; stainless steel; aluminum and magnesium alloys; iron; copper; nickel; brass; titanium. Exemplary polymer include polystyrene and crystal styrene; polyamides, especially Nylon 6, Nylon 66, Nylon 12, Nylon 11, Nylon 46 and their copolymers and aromatic nylons; polypropylene, isotactic and syndiotactic and their copolymers including atactic copolymers; polyethylene, including HDPE, MDPE, LDPE and polyethylene vinyl acetate, and ethylene vinyl acetate acrylic acid terpolymers including ionomers such as “Zurlyn” produced by DuPont; poly 1-butene, poly 2-methyl pentene; cyclic olefin co-polymers (e.g. Topas) sold by Ticona; polyester resins including PET, PETG, and COPE (copolyester); polycarbonate; polyurethanes; polyphenylene sulfide; acetal; copolymers of acrylonitrile, butadiene, and styrene (ABS); and others.

As noted above, in some embodiments, a material can be admixed with the polymer to enhance the thermal conductivity of the polymer. Exemplary fillers include calcium carbonate; carbon black; graphite; calcium silicates; talc; aluminum oxide; silica; metal particles including fibers and powdered metals, especially aluminum, iron, stainless steel and nickel; boron carbide; carbon nitride; boron nitride; wollastonite; clays, etc.

A wide range of thermochromic materials may be employed. The materials may be in the form of a solid, a liquid, or a liquid crystal and may be used neat or may be encapsulated or combined with another material. In some cases it is desirable to use a combination of more than one material to produce a range of temperature changes. Exemplary thermochromic materials include liquid crystal materials such as cholesteric liquid crystalline materials; waxy materials that scatter light below a given temperature and transmit light above; crystalline organic molecules or polymers with clearing points (melting points) at the temperature of interest; or inorganic thermo chromic materials

The color changing material may be applied to just a portion of the device, or may be applied to the entire device. Also, the material may be directly or indirectly incorporated into the device material.

In one embodiment, the device is constructed from a polymer having dispersed therein high aspect ratio (the ratio of one dimension to another, such as width to height or length to diameter) inorganic material or metal particles, for example particles with an aspect ratio of greater than about 5, the particles being fabricated of, for example, aluminum, boron carbide, carbon nitride, etc. In another embodiment the device is constructed from a polymer having dispersed therein high aspect ratio metal particles for example particles with an aspect ratio of greater than about 5, the particles being fabricated of for example aluminum, boron carbide, carbon nitride, etc. The article is produced by a manufacturing operation such as extrusion or injection molding that imparts significant orientation to the metal particles such that the materials has anisotropic thermal conductivity, particularly where the conductivity in the axial direction is greater than in the radial direction.

In another embodiment, the device comprise at least a first inner element and a surrounding element wherein the first inner element is an elongate element in the axial direction and comprised of highly thermally conductive material, plastic or metal, the thermal conductivity being preferably greater than 5 W/(m·K) and more preferably greater than 100 W/(m·K). In another embodiment, at least one surrounding element is comprised of a low thermal conductivity material (e.g., thermal conductivity of less than about 5 W/(m·K)) and is substantially interposed between the inner element and the object being monitored.

An example of such an embodiment can be constructed by, for example, using a two inch nail, or similarly shaped elongate object having opposing ends, one end adapted for insertion into an item. In this example, the second end flat or rounded, but more generally can be of any shape. A sheath of surrounding material is prepared by overmolding polyethylene to, for example, a thickness of 1 mm, along an upper ˜1.5 inches of the elongate body of the device. In this example, a polyethylene sheath is disposed along the elongate body of the device, extending from the end adapted for insertion to the opposing end and over the edges of flat second end. Next, a ˜0.2 mm thick thermochromic material is applied to the flat, second end of the device to form an indicating member. As noted above, the thermochromic material can optionally be overcoated with ˜1 mm clear plastic (opaque or transparent). The resulting device has a conductive path running from the end adapted for insertion to the opposing end comprising the thermochromic material. When the device is inserted into an object to be heated, the thermochromic indicating member is substantially in direct thermal communication with the inside of the item to be heated and is substantially insulated from the surrounding environment.

For food, the primary range of temperatures of interest will be from about 40° C. to about 90° C., more specifically from about 40° C. to 70° C. It will be appreciated that other temperature ranges are contemplated for use of the device in applications other than food preparation.

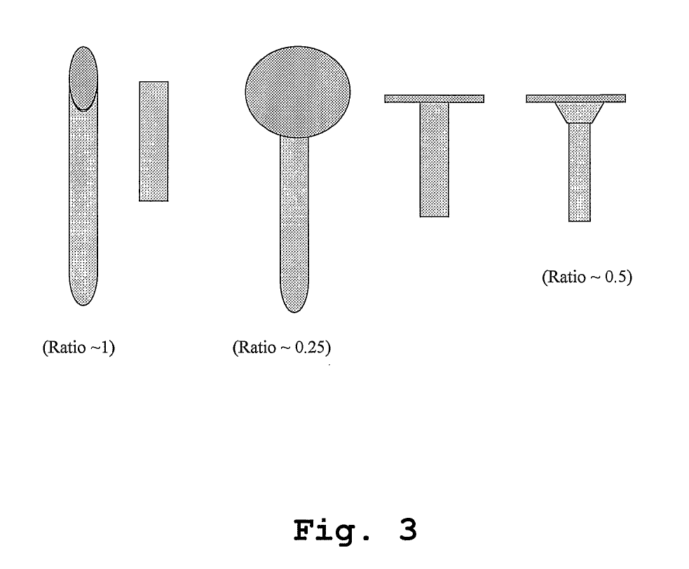

In designing the thermal indicating device, it is desirable, in one embodiment, that the thermal conductivity be greater than the product of L*0.5, wherein L is the length of the device measured in centimeters (cm). The end of the device on which the thermochromic indicating member is provided, in one embodiment, is circular or ring shaped. The relationship between the area of the elongate member and the end on which the thermochromic indicating member is disposed can be varied by altering the length and width of the elongate member and the diameter of the device end or of the thermochromic member, or both. In one embodiment, the ring shaped end has a diameter no greater than about twice that of the elongate member. Various configurations are illustrated in FIG. 3. A preferred embodiment is where the area of the ring shaped end is about equal to the area of the elongate member, giving an elongate member/end ratio of around 0.5. The device having an area of the ring shaped member that is considerably larger than the area of the elongate member, as shown in device with a ratio of about 0.25, is less preferred since thermal conductivity between the two members may be impaired.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A device for detecting the internal temperature of an object, comprising
an elongate member having a first end and a second opposing end,
a thermochromic material disposed on the first end;
wherein the second end is adapted for insertion into an object and the elongate member is adapted for thermal transfer such that the thermochromic material responds to a temperature detected by the second end when inserted into the object.

2. The device of claim 1, wherein said elongate member is comprised of a material having a thermal conductivity of at least about 0.25 W/(m K).

3. The device of claim 1, wherein said elongate member is at least partially coated with a polymeric sheath.

4. The device of claim 1, wherein said elongate member is a polymeric elongate member.

5. The device of claim 4, wherein said elongate member is further comprised of a thermally-conductive filler.

6. The device of claim 4, wherein said elongate member is further comprised of an inorganic particle having an aspect ratio of greater than about 5.

7. The device of claim 1, wherein said object is a food item.

8. The device of claim 7, wherein said food item is a turkey.

9. The device of claim 7, wherein said thermochromic member responds to a temperature between about 40° C. to about 90° C.

10. A device for detecting the internal temperature of a food item, comprising
an elongate member having a first end and a second opposing end,
a thermochromic material disposed on the first end;
wherein the second end is adapted for insertion into the food item, and wherein the elongate member is adapted for thermal transfer such that the thermochromic material responds to an internal temperature of the food item detected by the second end when inserted into the food item.
